(19) United States
(12) Patent Application Publication
(10) Pub. No.: US 2026/0361419 A1
(43) Pub. Date: Nov. 12, 2026

(54) Quantum Link Device System and Method for Secure Quantum Authentication and Data Transfer

(71) Applicant: Edward Robert Starrs, FOLSOM, CA (US)

(72) Inventor: Edward Robert Starrs, FOLSOM, CA (US)

(73) Assignee: Qlok Inc, FOLSOM, CA (US)

(21) Appl. No.: 19/205,023

(22) Filed: May 12, 2025

(51) Int. Cl. H04B 10/70; H04L 9/06

(52) U.S. Cl. CPC H04B 10/70; H04L 9/0631

(57) ABSTRACT

A quantum link device system and method for secure quantum authentication and data transfer over 16-17 km. A consumer device, such as a mobile phone or laptop, with an embedded photonic chip (SOI/Si3N4, SNSPDs/APDs) and Qiskit software integrates with quantum hubs generating entangled photons via SPDC (10\hat{ }8 pairs/s, 95% fidelity). The system enables user authentication via Bell state correlations, device authentication via quantum triangulation (<1 ns latency), and secure data transmission through instant quantum encoding or hybrid CV-DV teleportation. Features include AI anomaly detection (95% accuracy), AES-256 verification, and a control system (10\hat{ }8 events/s), ensuring 99% breach prevention. Applications include military C2/ISR, healthcare, IoT, finance, and telecommunications, with a hub-and-spoke fiber network supporting scalable, quantum-safe security.

### CROSS-REFERENCE TO RELATED APPLICATIONS

This application claims priority as a non-provisional application related to U.S. patent application Ser. No. 19/194,251, filed Apr. 30, 2025, which is a Continuation-in-Part of U.S. patent application Ser. No. 19/087,242, filed Mar. 21, 2025, the disclosures of which are incorporated herein by reference.

### STATEMENT REGARDING FEDERALLY SPONSORED RESEARCH

This invention was not made with government support.

### BACKGROUND

### Field

The invention relates to systems and methods for secure transaction processing using quantum entanglement, implemented in consumer devices to authenticate users, devices, and transactions, and to transfer data securely in quantum or hybrid quantum-classical environments, with applications in military, healthcare, Internet of Things (IoT), finance, and telecommunications.

### Related Art

Traditional cryptographic systems, such as RSA and elliptic curve cryptography (ECC), rely on mathematical complexity vulnerable to quantum computing attacks, such as Shor's algorithm, which can compromise keys rapidly. Quantum key distribution (QKD) systems, such as those developed by ID Quantique, secure cryptographic keys through quantum principles but focus on key exchange rather than direct transaction authentication, leaving gaps in end-to-end security for high-value transactions. Classical transaction security systems depend on mathematical assumptions susceptible to quantum threats. Quantum teleportation protocols, as described in U.S. Patent Application No. 20040109631(2004), enable high-fidelity state transfer for computing but lack integration into consumer devices. Quantum communication systems, such as those in U.S. Patent Application No. 20110153257(2011), focus on hub-based computing, not device-centric authentication or data transfer. Quantum random access memory and blockchain systems, as in U.S. Pat. No. 11,093,850(2021) and U.S. Patent Application No. 20240340167(2024), address computing and ledger security, not consumer device applications. No known system integrates a quantum-capable consumer device with a hub-based quantum network for authentication, transaction authorization, and secure data transfer using instant encoding or hybrid quantum-classical teleportation, enhanced by device triangulation.

### SUMMARY

The Quantum Link Device (QLD) system and method provide a quantum-safe solution for secure transaction processing by integrating a consumer device, such as a mobile phone or laptop, with quantum hubs for authentication, authorization, and data transfer. The device employs an embedded photonic chip and software to receive entangled photons from hubs, enabling user authentication via Bell state correlations, device authentication via quantum triangulation with sub-nanosecond latency, and secure data transmission through instant quantum encoding or hybrid continuous-variable/discrete-variable (CV-DV) teleportation. The system operates over a 16-17 km single-mode fiber network with a loss of 0.2 dB/km, achieving 95% fidelity. Key features include spontaneous parametric down-conversion (SPDC) for photon generation, Bell-state analyzers with superconducting nanowire single-photon detectors (SNSPDs), AI-driven anomaly detection with 95% accuracy, and a control system processing 10\hat{ }8 quantum events per second. Applications include military command-and-control (C2) and intelligence, surveillance, and reconnaissance (ISR), healthcare data transfer, IoT smart cities, finance, and telecommunications, offering a scalable, physics-based security solution resistant to quantum computing threats.

### BRIEF DESCRIPTION OF DRAWINGS

FIG. 1 is a block diagram of the Quantum Link Device system, illustrating the quantum-capable device with a photonic chip and software, quantum hub with entanglement generation, fiber network, verification module, AI anomaly detection, tamper-proof mechanisms, quantum triangulation, and control system.

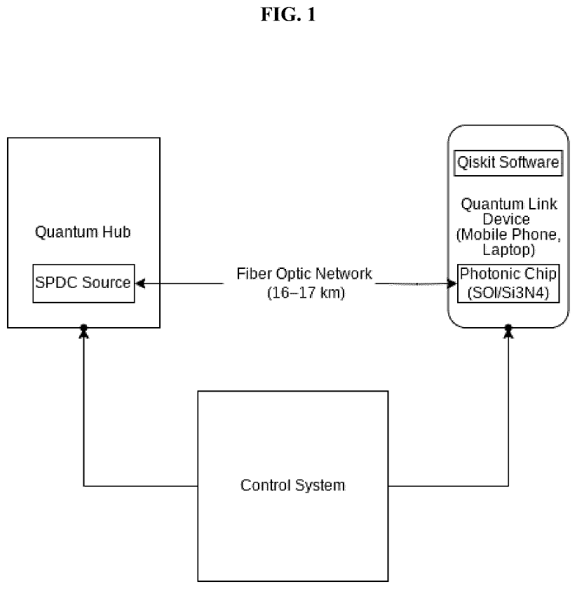

FIG. 2 is a flowchart of the transaction authentication and data transfer process, depicting photon generation, transmission, user/device authentication, instant encoding or teleportation, and authorization.

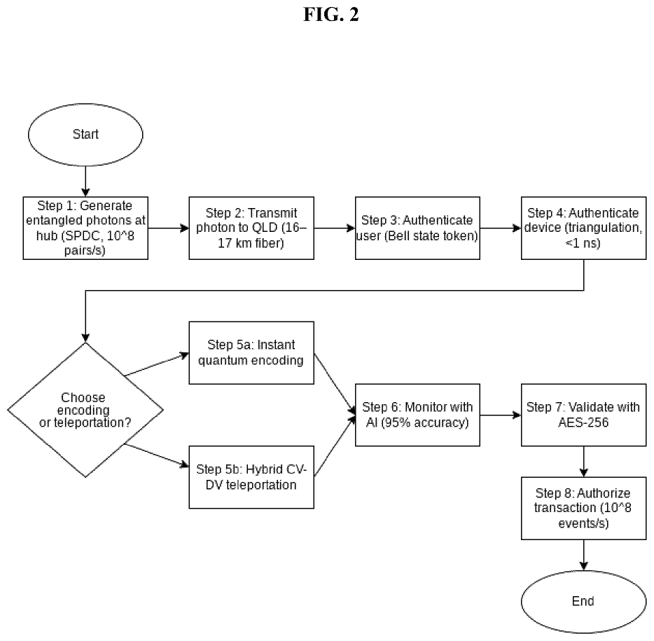

FIG. 3 is a schematic of the photon transmission network, showing a hub-and-spoke configuration with a central hub and endpoints within 16-17 km.

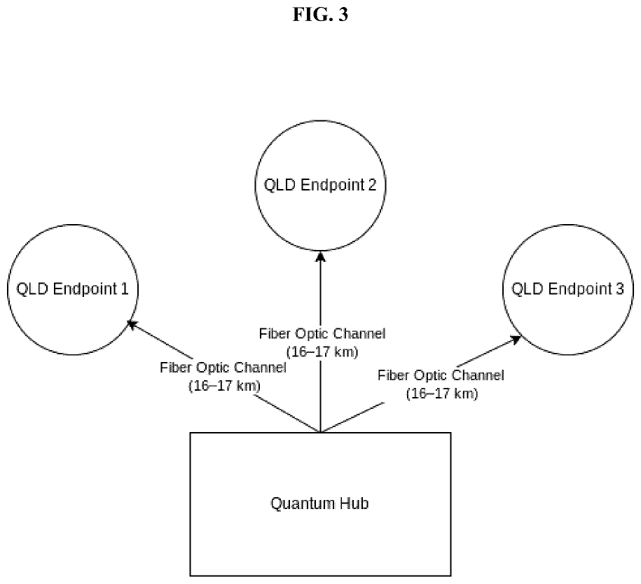

FIG. 4 is a diagram of the photonic chip in the Quantum Link Device, illustrating SOI or Si3N4 waveguides, beam splitters, wave plates, and detectors (SNSPDs or APDs).

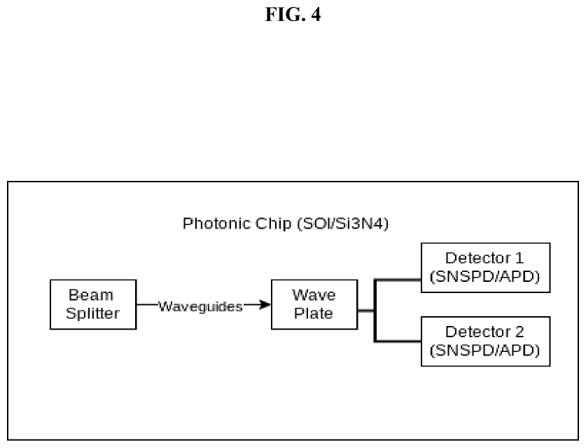

FIG. 5 is a diagram of the quantum teleportation process, showing Bell-state measurement, classical communication, and state reconstruction.

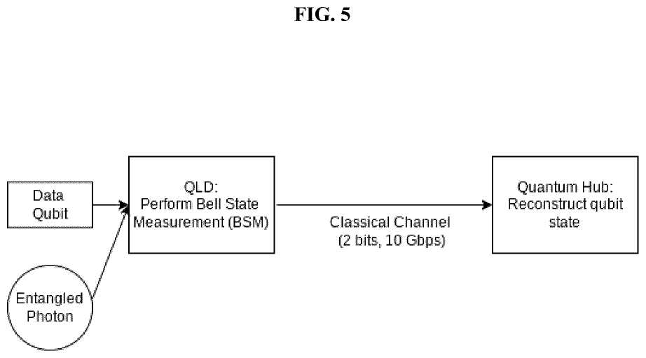

FIG. 6 is a diagram of the quantum triangulation process, illustrating device location verification with sub-nanosecond latency.

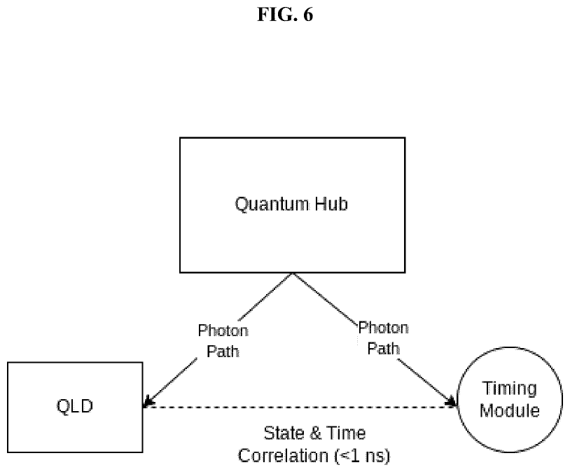

### DETAILED DESCRIPTION

The Quantum Link Device (QLD) system and method provide a quantum-safe solution for authenticating high-value transactions and transferring data securely using quantum entanglement, implemented in consumer devices such as mobile phones or laptops. The system integrates a quantum-capable device with quantum hubs, leveraging entanglement to authenticate users and devices, authorize transactions, and transmit data through instant quantum encoding or hybrid quantum-classical teleportation. Enhanced by AI-driven anomaly detection and quantum triangulation, the system addresses vulnerabilities such as eavesdropping, man-in-the-middle attacks, and quantum computing threats, achieving 99% breach prevention. Applications include military C2 and ISR, healthcare data transfer, IoT smart cities, finance, and telecommunications.

### System Components

Quantum Link Device: The device, such as a mobile phone or laptop, includes an embedded photonic chip and software for quantum operations. The chip, based on a silicon-on-insulator (SOI) or silicon nitride (Si3N4) platform, comprises waveguides with a loss of less than 0.5 dB/cm, beam splitters, wave plates, and detectors (superconducting nanowire single-photon detectors (SNSPDs) or avalanche photodiodes (APDs)) to receive and process entangled photons. SNSPDs operate at 1550 nm with 98% efficiency in 4 K micro-cryostats (approximately 10 cm\hat{ }3), while APDs provide 90% efficiency at room temperature for mobile phone applications. The chip performs Bell-state measurements (BSM) for teleportation and decodes photon states for authentication and data transfer. The software, implemented using Qiskit in C++and Python, executes quantum protocols for authentication, triangulation, and state reconstruction, processing data with a latency of less than 1 millisecond. The device connects to quantum hubs via single-mode fiber optic ports compatible with USB-C connectors.

Quantum Hub: The hub generates entangled photon pairs at a rate of 10\hat{ }8 pairs per second with 95% fidelity at 1550 nm using spontaneous parametric down-conversion (SPDC). The SPDC source comprises a 20 mm lithium niobate crystal, a 100 mW laser, beam splitters, and mirrors, producing pairs in a Bell state (|ψ [symbol] =(|00 [symbol] +|11 [symbol] )/√2). Multi-wavelength multiplexing enhances throughput, supporting high-volume transaction authentication and data transfer. The hub includes Bell-state analyzers with four SNSPDs (98% efficiency, 4 K cryostats) for decoding and BSM, and a control system processing 10\hat{ }8 quantum events per second.

Photon Transmission Network: The network distributes entangled photons from the hub to the QLD over 16-17 km, achieving a total loss of 3.3-3.5 dB. It comprises:
1. Centralized hubs with high-capacity SPDC sources to serve multiple QLD endpoints.
2. Single-mode fiber optic channels with a loss of 0.2 dB/km at 1550 nm, employing dense wavelength division multiplexing (DWDM) with 8 channels (C-band for classical, O-band for quantum) and crosstalk below 30 dB.

The network operates without quantum repeaters, optimizing short-range, high-security applications in a hub-and-spoke configuration with 2-3 endpoints within 16-17 km. For potential extended connectivity, satellite links with adaptive optics or classical Wi-Fi to local quantum hubs are contemplated.

Verification Module: The module authenticates transactions by verifying entanglement, comprising two Bell-state analyzers at the hub, each with four SNSPDs (98% efficiency, 4 K cryostats). Surface code error correction maintains an error rate below 5%, using 3 photons per bit to achieve approximately 33 Mbps throughput. The QLD's photonic chip performs complementary BSM for teleportation or decoding for instant encoding, ensuring end-to-end security.

AI Anomaly Detection Module: Implemented on a processor at the hub and device, the module uses a TensorFlow-based neural network to monitor photon states in real-time, detecting eavesdropping or man-in-the-middle attacks with 95% accuracy and a false positive rate below 5%. The module processes data at 100 Mbps, enhancing security for both instant encoding and teleportation.

Quantum Triangulation Module: The module verifies device locations with a latency of less than 1 nanosecond, using photon state correlations and arrival times processed via the control system's timing algorithms (e.g., White Rabbit protocol with <1 ns jitter). By correlating photon data between the hub and QLD, the module ensures devices are within the 16-17 km network, preventing spoofing in military C2 or IoT applications.

Redundant Classical Verification Module: The module applies AES-256 signatures to cross-validate quantum authentication results, preventing false authorizations. Integrated with the control system, it ensures compliance with GDPR and Cybersecurity Maturity Model Certification (CMMC) standards, processing classical data at 10 Gbps.

Control System: Executed on processors at the hub and QLD, the control system processes 10\hat{ }8 quantum events per second with a latency of less than 1 millisecond. Implemented in C++and Python with Qiskit integration, it supports hybrid quantum-classical routing (100 Mbps quantum, 10 Gbps classical), coordinating entanglement generation, photon distribution, verification, AI monitoring, triangulation, and classical validation.

### Method

The QLD method secures transactions through the following steps:
1. Generating entangled photon pairs at a rate of 10\hat{ }8 pairs per second with 95% fidelity at 1550 nm using an SPDC source at a quantum hub, equipped with a lithium niobate crystal and 100 mW laser.
2. Transmitting one photon from each pair to the QLD over 16-17 km via single-mode fiber optic channels with 0.2 dB/km loss, achieving a total loss of 3.3-3.5 dB, using a hub-and-spoke network with 2-3 endpoints.
3. Authenticating the user by verifying Bell state correlations between the hub's retained photon and the QLD's received photon, using the QLD's photonic chip to decode a user-specific token (e.g., polarization sequence).
4. Authenticating the device by verifying its location within 16-17 km using quantum triangulation, analyzing photon arrival times with sub-nanosecond latency.
5. Authorizing and transferring transaction data using one of:
   a. Instant quantum encoding, where data is encoded on the hub's retained photon (e.g., vertical polarization for “1”) to instantly set the QLD's photon state, decoded by the QLD's chip.
   b. Hybrid quantum-classical teleportation, where the QLD performs a Bell-state measurement (BSM) on the data qubit and received photon, sends two classical bits to the hub via a 10 Gbps classical channel, and the hub reconstructs the qubit state using unitary operations.
6. Monitoring photon states in real-time with an AI anomaly detection module (TensorFlow, 95% accuracy, <5% false positives) to detect eavesdropping or attacks.
7. Validating the transaction with AES-256 signatures to prevent false authorizations, ensuring GDPR and CMMC compliance.
8. Authorizing the transaction using a control system processing 10\hat{ }8 events per second, for applications in military, healthcare, IoT, finance, and telecommunications.

### Example

In a military command-and-control (C2) scenario, a TQL hub generates 10\hat{ }8 entangled photon pairs per second using an SPDC source. One photon is transmitted 16 km to a soldier's QLD-equipped mobile phone via single-mode fiber with 3.3 dB loss. The soldier authenticates using a Bell state token (e.g., polarization sequence), verified by the QLD's photonic chip in 5 milliseconds. Quantum triangulation confirms the device's location with <1 ns latency. A command (e.g., a 4-bit token “1010”) is transferred via instant encoding or hybrid teleportation (BSM on the QLD, classical bits to the hub, state reconstruction), monitored by AI (95% accuracy) and validated with AES- 256, ensuring secure authorization with 99% breach prevention.

### Alternative Embodiments

The QLD system may use silicon nitride (Si3N4) instead of SOI for enhanced waveguide performance. APDs may replace SNSPDs in mobile phones for room-temperature operation, trading 90% efficiency for simplicity. A modular dongle with a quantum chip may connect to devices lacking embedded chips. The network may employ ultra-low-loss fibers (0.15 dB/km) to extend the range to 22-23 km or integrate quantum repeaters for 50 km connectivity, as in QETS. Wireless or satellite links may replace fiber for global applications. The AI module may use PyTorch instead of TensorFlow for improved anomaly detection. These variations maintain core functionality while addressing diverse deployment needs.

### Applications

The QLD system secures transactions in multiple industries:
1. Military: Authenticates C2 and ISR communications with 99% breach prevention, using triangulation for endpoint verification.
2. Healthcare: Secures HIPAA-compliant patient data transfer within 16-17 km, protecting sensitive records.
3. IoT: Enables secure authentication for smart city devices (e.g., traffic sensors) with triangulation ensuring legitimacy.
4. Finance: Protects high-value banking transactions, preventing fraud with quantum-secure encoding or teleportation.
5. Telecommunications: Supports secure network authentication and data transfer, leveraging hybrid quantum-classical protocols.

The hub-and-spoke configuration supports scalable deployments in tactical and urban environments.

### Validation

The system's performance, including 95% fidelity, 98% SNSPD efficiency, and 95% AI accuracy, has been validated through testing at university facilities, ensuring reliability for real-world applications.

1. A quantum-safe transaction security system for authenticating and processing transactions, comprising:
a. a quantum link device configured as a consumer device, including an embedded photonic chip with a silicon-on-insulator (SOI) or silicon nitride (Si3N4) platform, waveguides with a loss of less than 0.5 dB/cm, and detectors selected from superconducting nanowire single-photon detectors (SNSPDs) or avalanche photodiodes (APDs), and software implemented in Qiskit for quantum protocols;
b. a quantum hub including an entanglement generation module configured to produce entangled photon pairs at a rate of 10\hat{ }8 pairs per second with a fidelity of at least 95% at 1550 nm using spontaneous parametric down-conversion (SPDC);
c. a photon transmission network comprising single-mode fiber optic channels with a loss of 0.2 dB/km, configured to distribute one photon from each pair from the hub to the quantum link device over 16-17 km with a total loss of 3.3-3.5 dB;
d. a quantum encoding module configured to encode data on a retained photon at the hub to instantly set the state of the transmitted photon or to perform hybrid quantum-classical teleportation by Bell-state measurement (BSM) on the quantum link device and classical communication to the hub;
e. a verification module at the hub, comprising at least two Bell-state analyzers, each with four SNSPDs operating at 98% efficiency at 1550 nm in 4 K cryostats, configured to decode the transmitted photon or reconstruct teleported states for transaction authentication;
f. an artificial intelligence (AI) anomaly detection module, implemented on processors at the hub and quantum link device, configured to monitor photon states in real-time and detect manipulations indicative of eavesdropping or attacks with an accuracy of at least 95% and a false positive rate below 5%;
g. a quantum triangulation module configured to verify the location of the quantum link device using photon state correlations and arrival times with a latency of less than 1 nanosecond;
h. a redundant classical verification module configured to apply AES-256 signatures to validate transaction authorizations, ensuring compliance with GDPR and CMMC standards;
i. a control system, executed on processors at the hub and quantum link device, configured to process at least 10\hat{ }8 quantum events per second with a latency of less than 1 millisecond, integrating the quantum link device, quantum hub, photon transmission network, verification module, AI anomaly detection module, quantum triangulation module, and redundant classical verification module to authenticate and process transactions for military, healthcare, Internet of Things (IoT), finance, and telecommunications applications.

2. The system of claim 1, wherein the photonic chip comprises waveguides, beam splitters, wave plates, and detectors configured to perform BSM for teleportation or decode photon states for instant encoding, with SNSPDs operating at 98% efficiency in 4 K micro-cryostats or APDs at 90% efficiency at room temperature.

3. The system of claim 1, wherein the photon transmission network has a total loss of 3.3-3.5 dB over 16-17 km, operating without quantum repeaters in a hub-and-spoke configuration with 2-3 endpoints.

4. The system of claim 1, wherein the verification module implements surface code error correction with an error rate below 5%, using 3 photons per bit to achieve a throughput of approximately 33 Mbps.

5. The system of claim 1, wherein the quantum encoding module supports hybrid CV-DV teleportation, performing BSM on the quantum link device and transmitting two classical bits to the hub for state reconstruction.

6. The system of claim 1, wherein the quantum triangulation module verifies device locations by analyzing photon arrival times and state correlations, processed via timing algorithms, achieving a latency of less than 1 nanosecond.

7. The system of claim 1, wherein the AI anomaly detection module utilizes a TensorFlow-based neural network trained to identify photon state manipulations with a false positive rate of less than 5%.

8. The system of claim 1, wherein the redundant classical verification module cross-validates quantum authentication results using AES-256 signatures, ensuring GDPR and CMMC compliance.

9. The system of claim 1, wherein the control system employs C++and Python software with Qiskit integration, supporting hybrid quantum-classical routing at 100 Mbps quantum and 10 Gbps classical speeds.

10. The system of claim 1, wherein the quantum link device is configured as a mobile phone or laptop with a fiber optic port for connection to the photon transmission network.

11. A method for quantum-safe transaction security, comprising:
a. generating entangled photon pairs at a rate of 10\hat{ }8 pairs per second with a fidelity of at least 95% at 1550 nm using an SPDC source at a quantum hub;
b. transmitting one photon from each pair to a quantum link device configured as a consumer device over 16-17 km via single-mode fiber optic channels with a loss of 0.2 dB/km, achieving a total loss of 3.3-3.5 dB;
c. authenticating a user by verifying Bell state correlations between a retained photon at the hub and the transmitted photon at the quantum link device, using an embedded photonic chip to decode a user-specific token;
d. authenticating the quantum link device by verifying its location within 16-17 km using quantum triangulation with a latency of less than 1 nanosecond;
e. authorizing and transferring transaction data using one of:
i. instant quantum encoding, encoding data on the retained photon at the hub to instantly set the transmitted photon's state, decoded by the quantum link device;
ii. hybrid quantum-classical teleportation, performing BSM on a data qubit and the transmitted photon at the quantum link device, transmitting two classical bits to the hub, and reconstructing the qubit state;
f. monitoring photon states in real-time with an AI anomaly detection module to detect manipulations with an accuracy of at least 95%;
g. validating the transaction with redundant AES-256 signatures to prevent false authorizations;
h. authorizing the transaction using a control system processing at least 10\hat{ }8 quantum events per second with a latency of less than 1 millisecond, for military, healthcare, IoT, finance, and telecommunications applications.

12. The method of claim 11, wherein teleportation employs hybrid CV-DV entanglement, with BSM performed on the quantum link device and classical bits transmitted at 10 Gbps to the hub for state reconstruction.

13. The method of claim 11, wherein decoding includes surface code error correction with 3 photons per bit, achieving a throughput of approximately 33 Mbps.

14. The method of claim 11, wherein transmitting uses a hub-and-spoke network configuration with a central hub and 2-3 endpoints within 16-17 km.

15. The method of claim 11, wherein verifying device locations uses photon arrival times and state correlations, processed via timing algorithms, to achieve triangulation with a latency of less than 1 nanosecond.
